(19) United States
(12) Patent Application Publication
(10) Pub. No.: US 2026/0175494 A1
(43) Pub. Date: Jun. 25, 2026

(54) PRESS-MOLDING DEVICE

(71) Applicant: Panasonic Intellectual Property Management Co., Ltd., Osaka (JP)

(72) Inventors: HIDEAKI HAMADA, Hyogo (JP); HIROYUKI NAOE, Shiga (JP); MASATO OMORI, Shiga (JP)

(21) Appl. No.: 19/533,355

(22) Filed: Feb. 9, 2026

Related U.S. Application Data
(63) Continuation of application No. PCT/JP2024/032377, filed on Sep. 10, 2024.

(30) Foreign Application Priority Data
Oct. 12, 2023 (JP) 2023-176989

(51) Int. Cl. B29C 45/66; B29C 45/33

(52) U.S. Cl. CPC B29C 45/661; B29C 45/33; B29C 45/332

(57) ABSTRACT

Press-molding device (100) processes workpiece (5), and includes: punch (1); die (2) including hollow portion (2a) into which the punch is inserted; material presser (3) disposed on an outer periphery of the punch and facing the die; pad (6) that is disposed in the hollow portion of the die, is movable in a moving direction of the punch, and includes a surface that is on a side opposite to the moving direction and is configured to be in contact with the workpiece; pressing portion (33) that includes piston rod (7) including a first end portion on the side opposite to the moving direction, the first end portion being in contact with the pad, and is configured to press the pad toward the punch by moving the piston rod in a direction opposite to the moving direction; and load sensor (12) that is in contact with a second end portion of piston rod (7) in the moving direction and detects a load applied to the pad and the piston rod.

### TECHNICAL FIELD

The present disclosure relates to a press-molding device.

### BACKGROUND ART

It is generally known to perform production while measuring a working load when performing punching, bending, drawing, and the like on a plate-shaped workpiece by press working.

For example, PTL 1 discloses a punching machine including a punch, a die, a holder, and a counter, in which a metal material to be processed is sandwiched and held between the die and the holder, and the punch is moved to shear the metal material to be processed, with the punch and the die. In the punching machine described in PTL 1, the metal material to be processed is sandwiched between the punch and the counter, an electrical current is applied between an electrode disposed in the holder and an electrode disposed in the counter, and an electrical current is applied to a portion of the metal material to be sheared to melt and rupture the portion. The time point (time) at which the electrical current is started to be applied between the electrodes is determined by detecting a shear load by a sensor.

PTL 2 discloses a punching device that punches a flat material to be processed, with a punch. The punching device described in PTL 2 includes a measuring instrument for obtaining translational forces generated in directions of two orthogonal axes in a plane orthogonal to an axis extending in a punching direction by the punch, among forces generated when the material to be processed is punched.

### CITATION LIST

### Patent Literature

PTL 1: Unexamined Japanese Patent Publication No. 2005-46873
PTL 2: Unexamined Japanese Patent Publication No. 2020-138210

### SUMMARY OF THE INVENTION

In the devices described in PTL1 and PTL2, there is room for improvement in accurately detecting only a load applied to a workpiece.

The present disclosure provides a press-molding device capable of accurately detecting only a load applied to a workpiece.

A press-molding device according to an aspect of the present disclosure processes a workpiece, and includes:
a punch;
a die including a hollow portion into which the punch is inserted;
a material presser disposed on an outer periphery of the punch and facing the die;
a pad that
   is disposed in the hollow portion of the die,
   is movable in a moving direction of the punch, and
   includes a surface that is on a side opposite to the moving direction and is configured to be in contact with the workpiece;
a pressing portion that
   includes a piston rod including a first end portion on the side opposite to the moving direction, the first end portion being in contact with the pad, and
   is configured to press the pad toward the punch by moving the piston rod in a direction opposite to the moving direction; and
a load sensor that is in contact with a second end portion of the piston rod in the moving direction and detects a load applied to the pad and the piston rod.

According to the present disclosure, since the load sensor is in contact with the end portion of the piston rod in the moving direction on the die side, for example, even if sliding resistance between the material presser and the punch increases due to a disturbance factor or the like, an effect on the load detection by the load sensor can be reduced, and it is possible to provide the press-molding device capable of accurately detecting only a load applied to a workpiece.

### BRIEF DESCRIPTION OF THE DRAWINGS

FIG. 1 is a schematic diagram illustrating an example of a press-molding working device according to a first exemplary embodiment of the present disclosure.

FIG. 2 is a schematic diagram illustrating a process of performing molding work on a workpiece with a press-molding device.

FIG. 3 is a flowchart illustrating an example of processing of a press-molding device according to a first exemplary embodiment of the present disclosure.

FIG. 4 is a graph illustrating an example of a relationship between a load applied to a load sensor and a position of a punch when a workpiece is subjected to molding work by the press-molding device.

### DESCRIPTION OF EMBODIMENTS

### Background of the Present Disclosure

Press working is generally used in a wide variety of fields such as home appliances, precision machines, and automobile parts. For example, in punching, bending, drawing, and the like in which press working is performed on a plate-shaped workpiece, the workpiece loaded on a die is pressed by a material presser, and a portion of the workpiece is pushed into a hollow portion of the die, and punched or molded by a punch. Thus, the workpiece is processed into a predetermined shape.

As a press-molding device that performs press working, there is known a device that controls a processing state while monitoring a load (working resistance) applied to a tool during the work by a load sensor attached to a die tool such as a punch.

The present inventors have newly found that there is a problem that only a load applied to a workpiece cannot be accurately detected in a case where a load sensor is attached to a punch. For example, in a case where pressure of a material presser or the like cannot be sufficiently secured, sliding resistance between the material presser and the punch may increase due to a disturbance factor or the like in which a force of the material presser is applied in a direction of a side surface of the punch. In a case where the load sensor is attached on the punch side, a working reaction force (working resistance) transmitted to the load sensor via the punch increases due to an increase in the sliding resistance between the material presser and the punch. Therefore, a load detected by the load sensor is measured at a value greater than a molding load for actually molding the workpiece.

The present inventors have studied a press-molding device capable of stably performing load sensing on a workpiece so as to accurately detect only a load applied to the workpiece in press-molding work, and have reached the present disclosure.

One exemplary embodiment of the present disclosure will now be described with reference to the accompanying drawings. Note that description below is merely exemplary in nature, and is not intended to limit the present disclosure, its application, or its use. Moreover, the drawings are each schematic, and for example, ratios of respective dimensions and the like do not necessarily equal to actual ratios.

### First Exemplary Embodiment

### [Overall Configuration]

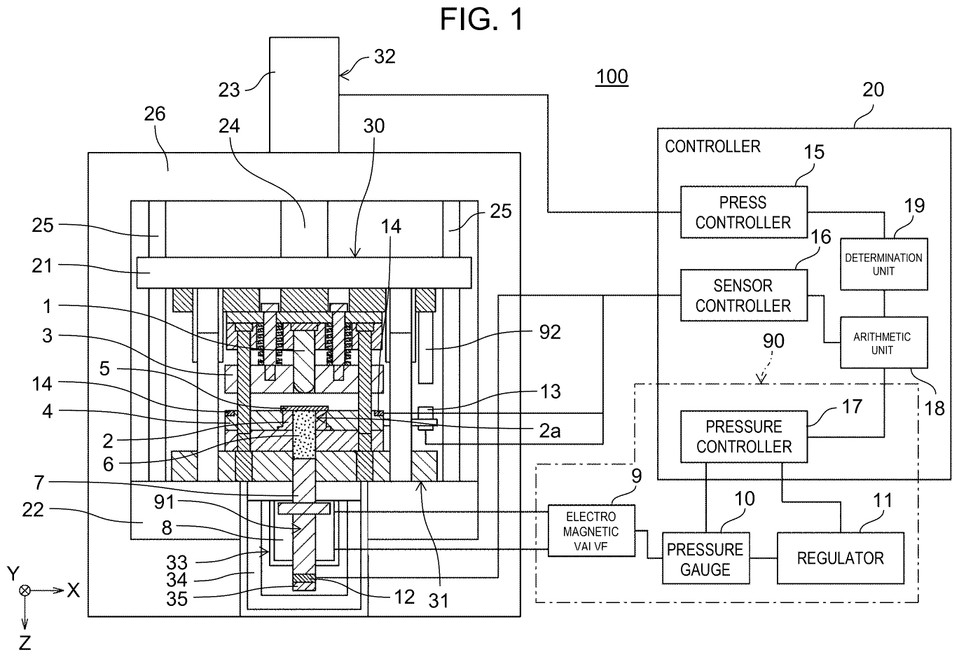

FIG. 1 is a schematic diagram illustrating press-molding device 100 according to a first exemplary embodiment of the present disclosure. The X-Y-Z coordinate system illustrated in the drawing is provided to facilitate the understanding of the exemplary embodiment, and is not intended to limit the exemplary embodiment. In FIG. 1, an X direction is a width direction of press-molding device 100, a Y direction is a depth direction of press-molding device 100, and a Z direction is a height direction of press-molding device 100.

With reference to FIG. 1, press-molding device 100 according to the present exemplary embodiment will be described.

As illustrated in FIG. 1, press-molding device 100 performs press-molding work on workpiece 5, and is, for example, a servo screw press device that can be controlled with high accuracy. Workpiece 5 is, for example, a plate-shaped metal plate.

Press-molding device 100 includes press device body 26 and controller 20. In the present exemplary embodiment, press-molding device 100 includes electromagnetic valve 9, pressure gauge 10, and regulator 11.

Press device body 26, controller 20, electromagnetic valve 9, pressure gauge 10, and regulator 11 may be accommodated in one housing. For example, controller 20 may be accommodated in a housing of press device body 26. Alternatively, press device body 26, controller 20, electromagnetic valve 9, pressure gauge 10, and regulator 11 may be separately disposed at separate places instead of being accommodated in one housing. In the present disclosure, an aspect including press device body 26, controller 20, electromagnetic valve 9, pressure gauge 10, and regulator 11 separately disposed as described above may also be referred to as “press-molding device 100”. Such an aspect may be referred to as a “press-molding work system”.

### <Press Device Body>

Press device body 26 includes upper mold 30 and lower mold 31. In lower mold 31, pad 6, load sensor 12, position sensor 13, gap sensor 14, and pressing portion 33 such as cylinder 8 having piston rod 7 are disposed. Press device body 26 includes slide 21 to which upper mold 30 is attached, bolster 22 to which lower mold 31 is attached, and driver 32 that moves upper mold 30 in a vertical direction (Z direction).

Upper mold 30 includes punch 1 and material presser 3. Upper mold 30 includes a punch holder that holds punch 1 and material presser 3 and is attached to slide 21.

Punch 1 is a tool for press-molding workpiece 5 by moving in a pressing direction (Z direction). Punch 1 is attached to slide 21 together with material presser 3.

A tip of punch 1 has, for example, a spherical shape. In the present exemplary embodiment, the tip of punch 1 has a spherical shape having a diameter of 6.0 mm, and punch 1 press-molds workpiece 5 into a spherical shape.

Punch 1 includes, for example, a cemented carbide material. An example of the cemented carbide material is a generic term of a metal (alloy) in which at least one of carbides of tungsten (W), chromium (Cr), molybdenum (Mo), titanium (Ti), zirconium (Zr), hafnium (Hf), vanadium (V), niobium (Nb), and tantalum (Ta) is bonded with an Fe-group metal (Fe, Co, or Ni). As the cemented carbide material, for example, an alloy corresponding to VM-40 of the Cemented Carbide Tool Association Standard (CIS) can be adopted.

Material presser 3 is disposed on an outer periphery of punch 1. Material presser 3 has a pressing surface that comes into contact with workpiece 5. Material presser 3 has a plate shape, and is provided with a through hole through which punch 1 can move. The through hole is provided at a center of material presser 3. Material presser 3 faces die 2 of lower mold 31 described later.

Punch 1 and material presser 3 are attached to slide 21 via the punch holder, for example. Slide 21 is a component movable along shaft 25 extending in the vertical direction (Z direction). Slide 21 is connected to driver 32. Slide 21 is moved in the vertical direction along shaft 25 by driver 32. As a result, punch 1 attached to slide 21 moves up and down together with material presser 3.

Lower mold 31 includes die 2 and die plate 4. Lower mold 31 includes a die holder that holds die 2 and die plate 4 and attaches die 2 and die plate 4 to bolster 22.

Die 2 is provided with hollow portion 2a into which punch 1 is inserted, and is a component on which workpiece 5 is placed. Hollow portion 2a is a through hole penetrating die 2 in the vertical direction (Z direction). In the present exemplary embodiment, hollow portion 2a is formed as a circular through hole. A vicinity of an inlet of hollow portion 2a of die 2 has an R shape as viewed from upper mold 30.

Similarly to punch 1, die 2 includes, for example, a cemented carbide material.

Die plate 4 is a member that holds die 2. Die plate 4 may be configured separately from die 2, or may be configured integrally with die 2.

Die 2 and die plate 4 are attached to bolster 22 via, for example, the die holder. Bolster 22 is a table for attaching lower mold 31. Die 2 and die plate 4 are attached and fixed to bolster 22.

Pad 6 is disposed in hollow portion 2a of die 2. Pad 6 is disposed so as to be movable in the vertical direction (Z direction) in hollow portion 2a of die 2. Pad 6 is constituted by, for example, a quenching member such as SKD11, SKH51, or powdered high-speed steel.

Pad 6 has, for example, a cylindrical columnar shape. An upper surface of pad 6 comes into contact with workpiece 5. A lower surface of pad 6 is in contact with and fixed to an upper surface of piston rod 7.

A lower surface of piston rod 7 is in contact with load sensor 12, and a lower surface of load sensor 12 is in contact with and fixed to an upper surface of load sensor holding member 35. Load sensor holding member 35 can be configured as, for example, a head portion of a bolt that penetrates a through hole of ring-shaped load sensor 12 and is screwed and fixed to a female screw portion of the lower surface of piston rod 7.

The height of pad 6 is greater than the depth of hollow portion 2a of die 2. In the present exemplary embodiment, the die holder is provided with a hollow portion which is a through hole communicating with hollow portion 2a of die 2. Therefore, pad 6 is disposed in hollow portion 2a of die 2 and the hollow portion of the die holder.

Load sensor 12 detects a load from when load sensor holding member 35 comes into contact with bottomed component 34, which is an example of a stopper, in a process in which punch 1 pushes pad 6 downward via workpiece 5. That is, load sensor 12 detects a load applied in the pressing direction (Z direction) of punch 1, in other words, a load applied to pad 6, piston rod 7 of pressing portion 33, and load sensor holding member 35. Bottomed component 34, which is an example of the stopper, is constituted by a rectangular box surrounding pressing portion 33 as an example, but is not limited thereto, and may be a member having any shape and fixed on a side of lower mold 31 as long as the member comes into contact with load sensor holding member 35 at the position of a bottom portion of the box of bottomed component 34 in FIG. 1 to regulate descending.

Load sensor 12 is disposed between piston rod 7 and load sensor holding member 35. Since load sensor 12 is used as a cylinder double-rod type, load sensor 12 is always located below pressing portion 33.

Information detected by load sensor 12 is transmitted to controller 20.

Position sensor 13 acquires information for detecting the position of punch 1. For example, position sensor 13 can be constituted by, for example, a displacement sensor that measures a minute distance interval from a measurement object 92 in a non-contact manner.

Position sensor 13 can be attached to any position where information for detecting the position of punch 1 can be acquired. In the present exemplary embodiment, position sensor 13 is attached to lower mold 31 and detects the distance between position sensor 13 and measurement object 92 fixed to upper mold 30. The position of punch 1 can be detected based on the distance between upper mold 30 and position sensor 13.

Press device body 26 may be provided with a plurality of position sensors 13. For example, four position sensors 13 may be disposed near four corners of an upper surface of lower mold 31. It is possible to detect whether upper mold 30 and lower mold 31 are arranged in parallel, based on information detected by four position sensors 13.

Gap sensor 14 detects an amount of a gap between die plate 4 and material presser 3. For example, gap sensor 14 can be constituted by a displacement sensor. Information detected by gap sensor 14 is transmitted to controller 20.

Gap sensor 14 can be attached to any place where the amount of the gap between die plate 4 and material presser 3 can be measured. In the present exemplary embodiment, press device body 26 includes four gap sensors 14, and four gap sensors 14 are attached to four corners of an upper surface of die plate 4. In this case, the inclination or the like of material presser 3 relative to die plate 4 can be detected based on the information of the amount of the gap detected by four gap sensors 14.

Pressing portion 33 presses pad 6 toward punch 1. That is, pressing portion 33 applies an upward pressing force to pad 6. Pressing portion 33 constantly applies a constant pressing force to pad 6.

In the present exemplary embodiment, pressing portion 33 is constituted by cylinder 8 having piston rod 7. Piston rod 7 is movable in a moving direction (Z direction) of punch 1.

Cylinder 8 is an air cylinder and pushes up piston rod 7 toward punch 1 by air pressure. As a result, piston rod 7 presses pad 6 toward punch 1. In addition, in a process in which punch 1 pushes pad 6 downward via workpiece 5, pad 6 and piston rod 7 are lowered in the moving direction (Z direction) of punch 1 while the air pressure in the air cylinder is always maintained at a constant value.

In this case, cylinder 8 may be a low sliding resistance type cylinder that suppresses sliding resistance when piston rod 7 moves up and down.

Pad 6, piston rod 7, load sensor 12, and load sensor holding member 35 are connected and fixed in an axial direction with a fixing bolt or the like and integrated to form integrated component 91. Integrated component 91 is constituted by a rigid body that does not expand and contract in the axial direction except for load sensor 12.

Cylinder 8 of pressing portion 33 is controlled by pressure adjustment unit 90, specifically, electromagnetic valve 9, pressure gauge 10, regulator 11, and pressure controller 17 to be described later. Specifically, an internal pressure (air pressure) of cylinder 8 is controlled by pressure controller 17, electromagnetic valve 9, pressure gauge 10, and regulator 11. That is, based on the internal pressure of cylinder 8 detected by pressure gauge 10, pressure adjustment unit 90 controls regulator 11 (in other words, reduces the internal pressure) so as to maintain the internal pressure of cylinder 8 constant by pressure controller 17 when piston rod 7 descends (when the internal pressure rises), thereby adjusting the pressure.

Electromagnetic valve 9 controls supply and/or discharge of air from regulator 11 to cylinder 8.

Pressure gauge 10 detects the internal pressure (air pressure) of cylinder 8.

Regulator 11 adjusts the pressure of air supplied to cylinder 8 via electromagnetic valve 9. Regulator 11 may be a precision regulator or the like.

Electromagnetic valve 9, pressure gauge 10, and regulator 11 are controlled by controller 20.

Driver 32 is a component that drives slide 21 in the vertical direction. In the present exemplary embodiment, driver 32 includes servomotor 23 and ball screw 24 that is driven by servomotor 23.

Servomotor 23 is controlled by controller 20. Ball screw 24 is connected to slide 21 and is rotationally driven by servomotor 23. As a result, slide 21 is moved in the vertical direction.

Driver 32 is controlled by controller 20.

Note that workpiece 5 according to the present exemplary embodiment is a plate-shaped material to be processed by press-molding device 100. Workpieces 5 are conveyed in the X direction or the Y direction by a conveyor (not illustrated) in accordance with a pressing operation of press device body 26, and are sequentially subjected to press working.

In the present exemplary embodiment, as an example, workpiece 5 includes SUS301-EH material which is a steel type classified as austenitic stainless steel. The SUS301-EH material is, for example, a material used as a mainspring or a spring of an automobile component. In the present exemplary embodiment, as an example, workpiece 5 has a thickness of 0.03 mm, hardness of 529 HV, and tensile strength of 1.679 N/mm².

In the present exemplary embodiment, the tip of punch 1 has a spherical shape as described above, but punch 1 may have a V-shaped, a U-shaped bent shape, or a cylindrical or box-shaped drawn shape. Accordingly, the shape of material presser 3 and the shape of die 2 are also planar shapes facing each other, but the shapes are not limited.

In the present exemplary embodiment, the example in which driver 32 is constituted by servomotor 23 and ball screw 24 has been described, but the present exemplary embodiment is not limited thereto. Driver 32 only needs to have a configuration capable of driving upper mold 30.

### <Controller>

Controller 20 controls an operation of press device body 26. Specifically, controller 20 controls driver 32, pressing portion 33, and pressure adjustment unit 90, that is, pressure controller 17 based on information from load sensor 12, position sensor 13, and gap sensor 14.

Controller 20 includes a processor and a storage. Controller 20 implements a predetermined function by the processor executing a command stored in the storage. The function of controller 20 may be implemented only by hardware, or may be implemented by a combination of the hardware and software. Controller 20 may include one or more processors.

The processor can include, for example, a microcomputer, a CPU, an MPU, a GPU, a DSU, an FPGA, an ASIC, and the like. The processor may be constituted by a dedicated electronic circuit designed to implement the predetermined function.

The storage is a storage medium that stores a program and data for implementing the function of controller 20. The storage can be implemented by a hard disk (HDD), an SSD, a RAM, a DRAM, a ferroelectric memory, a flash memory, a magnetic disk, or a combination thereof, for example.

In the present exemplary embodiment, controller 20 includes press controller 15, sensor controller 16, pressure controller 17, arithmetic unit 18, and determination unit 19. These constituent elements are implemented by the processor and the storage described above.

Press controller 15 controls driver 32. Specifically, press controller 15 is electrically connected to servomotor 23, and drives servomotor 23 by transmitting a drive signal. When servomotor 23 is driven, ball screw 24 rotates, and slide 21 connected to ball screw 24 can be vertically driven at a predetermined speed in the pressing direction (that is, in the Z direction).

Sensor controller 16 controls load sensor 12, position sensor 13, and gap sensor 14. Specifically, sensor controller 16 is electrically connected to load sensor 12, position sensor 13, and gap sensor 14, and outputs information detected by each of load sensor 12, position sensor 13, and gap sensor 14 to arithmetic unit 18.

Pressure controller 17 controls the internal pressure (that is, the air pressure) of cylinder 8 of pressing portion 33. Specifically, pressure controller 17 is electrically connected to electromagnetic valve 9, pressure gauge 10, and regulator 11. Pressure controller 17 controls opening and closing of electromagnetic valve 9 and controls supply of air from regulator 11 to cylinder 8. Pressure controller 17 controls regulator 11 based on the internal pressure of cylinder 8 detected by pressure gauge 10. Specifically, pressure controller 17 controls regulator 11 based on a pressure value detected by pressure gauge 10 such that the internal pressure of cylinder 8 is always maintained constant at any pressure.

Pressure controller 17 opens and closes electromagnetic valve 9 based on the pressure value detected by pressure gauge 10. For example, pressure controller 17 may close electromagnetic valve 9 in an abnormal state in which the pressure value detected by pressure gauge 10 exceeds a predetermined threshold value.

Arithmetic unit 18 calculates a molding load of workpiece 5 based on the information detected by load sensor 12 and position sensor 13.

Arithmetic unit 18 calculates the position of punch 1 based on the information detected by position sensor 13. Arithmetic unit 18 calculates the position of punch 1 from a bottom dead center based on the information detected by position sensor 13. In other words, arithmetic unit 18 calculates how much punch 1 is positioned above the bottom dead center. The bottom dead center of punch 1 is the lowest position that punch 1 can take.

For example, before upper mold 30 descends and position sensor 13 and upper mold 30 come into contact with each other (actually, since there is an adjustment margin of the bottom dead center position of punch 1, a gap of, for example, about 0.5 mm is provided without contact), a value detected by position sensor 13 is 0 at a bottom dead center reference position of punch 1. When the value detected by position sensor 13 is the bottom dead center reference position 0 of punch 1, arithmetic unit 18 can detect that punch 1 is at the bottom dead center. In addition, arithmetic unit 18 can detect that punch 1 is positioned higher than the bottom dead center in a case where the detected value is greater than the bottom dead center reference position 0 of punch 1, and that punch 1 is positioned lower than the bottom dead center in a case where the detected value is less than the bottom dead center reference position 0 of punch 1.

arithmetic unit 18 can determine the timing of detecting a load by load sensor 12 based on the information detected by position sensor 13, that is, information of the position of punch 1. Specifically, the timing of starting detection by load sensor 12 can be determined based on the information detected by position sensor 13 so that detection of a load applied to punch 1 in the pressing direction (Z direction) of punch 1 can be started at the same timing for each shot in the press-molding work. In this manner, the information detected by position sensor 13 can be used as a trigger for detecting a load applied in the pressing direction (Z direction) of punch 1.

In a case where four position sensors 13 are disposed at the four corners of the upper surface of lower mold 31, arithmetic unit 18 can detect whether upper mold 30 and lower mold 31 are arranged in parallel, based on values detected by four position sensors 13.

Arithmetic unit 18 generates a load waveform indicating a relationship between the load detected by load sensor 12 and the position of punch 1, and calculates the molding load of workpiece 5 based on the generated load waveform. For example, arithmetic unit 18 calculates the molding load of workpiece 5 based on the load obtained by load sensor 12 and a reaction force of punch 1.

Arithmetic unit 18 detects a gap between material presser 3 and die plate 4 and an inclination state of material presser 3 based on the information detected by gap sensor 14. For example, arithmetic unit 18 detects an abnormal state such as inclination of the pressing surface of material presser 3 relative to the upper surface of die plate 4 based on the information detected by four gap sensors 14 arranged at the four corners of the upper surface of die plate 4.

Determination unit 19 determines a pushing amount of punch 1 based on the molding load of workpiece 5 calculated by arithmetic unit 18. For example, when the molding load of workpiece 5 is less than a molding load of a non-defective product, the pushing amount of punch 1 is insufficient, and thus determination unit 19 outputs a signal for increasing the pushing amount of punch 1 to press controller 15. Press controller 15 having received the signal increases the pushing amount of punch 1 from servomotor 23 via ball screw 24. On the other hand, when the molding load of workpiece 5 is greater than the molding load of the non-defective product, the pushing amount of punch 1 is excessive, and thus determination unit 19 outputs a signal for decreasing the pushing amount of punch 1 to press controller 15. Press controller 15 having received the signal decreases the pushing amount of punch 1 from servomotor 23 via ball screw 24.

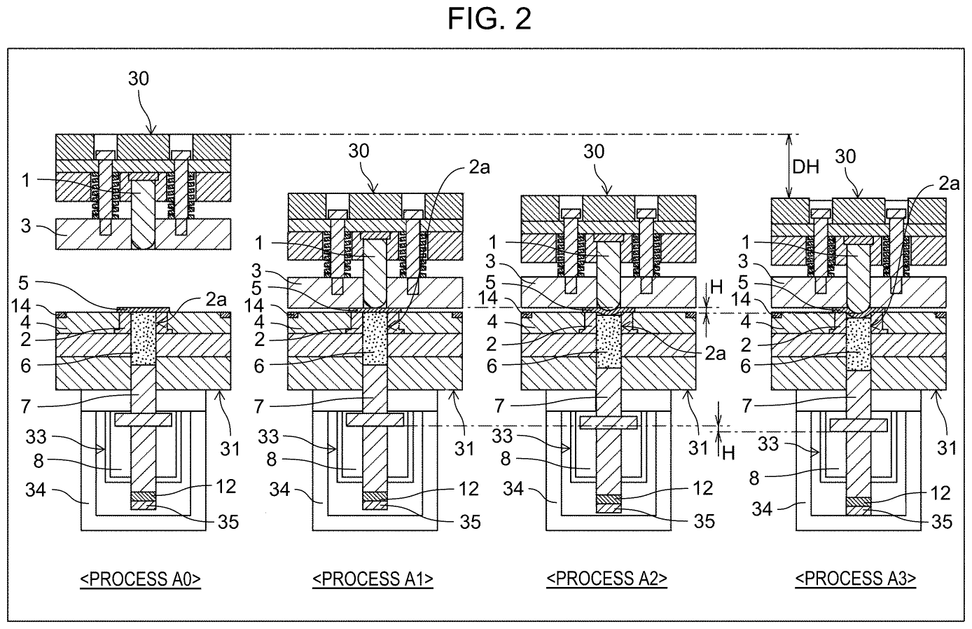

In addition to this, determination unit 19 can determine whether an abnormality is present in press-molding device 100. As will be described in detail in the section of operation below, for example, press-molding device 100 can determine whether the amount of the gap between material presser 3 and die plate 4 detected by gap sensor 14 in step S3 is an abnormal value by determination unit 19. Press-molding device 100 can determine whether the internal pressure of cylinder 8 detected by pressure gauge 10 in step S4 is an abnormal value by determination unit 19. Furthermore, determination unit 19 can determine whether molding has ended. Press-molding device 100 can also determine whether to change die height DH (see FIG. 2), by determination unit 19.

### [Operation]

One example of an operation of press-molding device 100 will be described with reference to FIG. 2.

FIG. 2 is a schematic diagram illustrating an example of a process of molding workpiece 5 by press-molding device 100 according to the first exemplary embodiment of the present disclosure. In FIG. 2, some constituent elements are not illustrated. Note that the reference sign “DH” in FIG. 2 indicates a die height, and the reference sign “H” indicates the pushing amount of punch 1.

As indicated by processes A0 to A3 in FIG. 2, punch 1 is attached to slide 21 together with material presser 3 that presses workpiece 5 against die 2 during the press-molding work. With the movement of slide 21, punch 1 is pressed against workpiece 5, and the press-molding work is performed.

Pad 6 is disposed in hollow portion 2a of die 2 facing punch 1, and the press-molding work is performed while cylinder 8 having piston rod 7 movable up and down via pad 6 positions workpiece 5 along the movement of punch 1 pressed against workpiece 5 and descending in the pressing direction (Z direction) such that workpiece 5 does not shift.

Next, processes A0 to A3 illustrated in FIG. 2 will be described in detail.

In process A0, punch 1 is located at a top dead center (before processing). The top dead center is the highest position that punch 1 can take. Workpiece 5 is placed on die 2 with punch 1 positioned at the top dead center. When the press-molding work is started, upper mold 30 including punch 1 descends from the top dead center in the pressing direction (Z direction) together with slide 21.

Next, in process A1, upper mold 30 descends and material presser 3 comes into contact with workpiece 5. When material presser 3 comes into contact with workpiece 5, the tip of punch 1 comes into contact with workpiece 5.

Next, in process A2, punch 1 descends in a state where material presser 3 is in contact with workpiece 5. Punch 1 sandwiches workpiece 5 with pad 6 positioned on a lower surface of workpiece 5. As a result, punch 1, workpiece 5, and pad 6 descend together. At this time, material presser 3 maintains a state of pressing workpiece 5, and performs a function of preventing workpiece 5 from being drawn into hollow portion 2a of die 2 by the load of a spring disposed in upper mold 30. In this state, load sensor holding member 35 and bottomed component 34 are not in contact with each other.

Next, in process A3, punch 1 further descends and reaches the bottom dead center. The operations of punch 1, pad 6, and material presser 3 are similar to those in process A2. Incidentally, load sensor holding member 35 and bottomed component 34 are completely in contact with each other in the state at the bottom dead center, but load sensor holding member 35 and bottomed component 34 start contacting each other several tens of micrometers before the state at the bottom dead center and the load is detected by load sensor 12 up to the bottom dead center.

### [Determination Processing in Press-Molding Work]

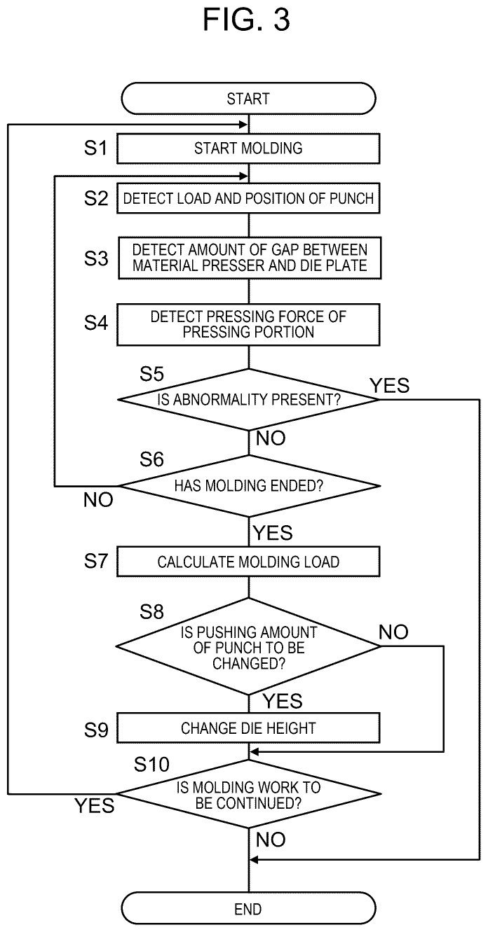

An example of determination processing in press-molding work by press-molding device 100 will be described with reference to FIG. 3.

FIG. 3 is a flowchart illustrating an example of the processing of the press-molding device according to the first exemplary embodiment of the present disclosure.

As illustrated in FIG. 3, in step S1, press-molding device 100 starts molding. When press-molding device 100 starts molding, as illustrated in FIG. 2, upper mold 30 including punch 1 descends together with slide 21 in the pressing direction (Z direction) from the state at the top dead center (process A0), and material presser 3 comes into contact with workpiece 5. When material presser 3 comes into contact with workpiece 5, upper mold 30 (including punch 1) fixed to slide 21 gradually starts descending, and the tip of punch 1 comes into contact with workpiece 5 (process A1). Thereafter, while punch 1 sandwiches workpiece 5 with pad 6 on the lower surface of workpiece 5, punch 1 is pushed halfway while punch 1, workpiece 5, and pad 6 descend (process A2). Furthermore, the descending of upper mold 30 (including punch 1) fixed to slide 21 progresses, and punch 1 reaches the bottom dead center (process A3).

Next, in step S2, press-molding device 100 detects the load and the position of punch 1. Press-molding device 100 detects the position of punch 1 based on the information detected by position sensor 13. For example, press-molding device 100 detects the position of punch 1 indicated in processes A0 to A3 in FIG. 2 based on the value detected by position sensor 13. Press-molding device 100 detects a load applied in the pressing direction (Z direction) of punch 1 by load sensor 12.

The detection of the load by load sensor 12 is performed in association with the detection of the position of punch 1 by position sensor 13. However, in the present exemplary embodiment, immediately before process A3 in FIG. 2, the load is detected by the load sensor 12 only during a period of time from when load sensor holding member 35 comes into contact with bottomed component 34 to when punch 1 reaches the bottom dead center.

For example, in press-molding device 100, the load applied to punch 1 is generated from the position where punch 1 starts contacting workpiece 5 by position sensor 13 (process A1 in FIG. 2) to the position where punch 1 reaches the bottom dead center (process A3 in FIG. 2). However, press-molding device 100 according to the present exemplary embodiment starts the detection by load sensor 12 from when load sensor holding member 35 comes into contact with bottomed component 34, and ends the detection by load sensor 12 when punch 1 reaches the bottom dead center. As a result, load sensor 12 detects a positional relationship of punch 1 and the load applied to punch 1. That is, load sensor 12 detects a force applied when punch 1 pushes pad 6 and piston rod 7 through workpiece 5 and a force for molding workpiece 5 together with the positional relationship of punch 1. When load sensor holding member 35 comes into contact with bottomed component 34, load sensor 12 starts detection, so that the contact can be reliably grasped. When the value detected by position sensor 13 is the bottom dead center reference position 0 of punch 1, arithmetic unit 18 can reliably detect that punch 1 is at the bottom dead center.

Next, in step S3, press-molding device 100 detects the amount of the gap between material presser 3 and die plate 4. For example, press-molding device 100 detects the amount of the gap between the pressing surface (lower surface) of material presser 3 and the upper surface of die plate 4 by four gap sensors 14 arranged at the four corners of the upper surface of die plate 4. Press-molding device 100 detects the amount of the gap by gap sensor 14 until punch 1 descends from the top dead center in the pressing direction (Z direction) and material presser 3 comes into contact with workpiece 5.

Next, in step S4, press-molding device 100 detects the pressing force of pressing portion 33. In the present exemplary embodiment, pressing portion 33 is constituted by cylinder 8 having piston rod 7, and cylinder 8 is an air cylinder as an example. Therefore, press-molding device 100 detects the internal pressure of cylinder 8 by pressure gauge 10.

Next, in step S5, press-molding device 100 determines whether an abnormality is present by determination unit 19. For example, press-molding device 100 determines whether the amount of the gap between material presser 3 and die plate 4 detected by gap sensor 14 in step S3 is an abnormal value by determination unit 19. For example, the abnormal value is determined by calculating a difference between amounts of the gap detected by four gap sensors 14 and determining whether the difference exceeds a predetermined threshold value by determination unit 19. For example, in a case where the difference between the amounts of the gap is greater than or equal to 5 μm, press-molding device 100 determines that the amount of the gap is an abnormal value by determination unit 19. The abnormal value or the threshold value may be changed depending on the size of the mold, the size of die plate 4, or the arrangement place of gap sensor 14.

Press-molding device 100 determines whether the internal pressure of cylinder 8 detected by pressure gauge 10 in step S4 is an abnormal value by determination unit 19. For example, the abnormal value is determined by determination unit 19 based on whether the pressure detected by pressure gauge 10 exceeds a predetermined threshold value. For example, in a case where the pressure value detected by pressure gauge 10 is not within a range of 0.45±0.02 MPa, press-molding device 100 determines that the internal pressure is an abnormal value by determination unit 19. The abnormal value or the threshold value may be changed depending on the molding load of workpiece 5.

Next, in step S5, if determination unit 19 determines that the value detected in step S3 or S4 is an abnormal value, the processing ends even during the molding. If determination unit 19 determines that the value detected in step S3 or S4 is not an abnormal value, the processing proceeds to step S6.

In step S6, press-molding device 100 determines whether the molding has ended by determination unit 19. For example, determination unit 19 of press-molding device 100 determines whether punch 1 has reached the bottom dead center, based on the information detected by position sensor 13. If determination unit 19 determines that punch 1 has reached the bottom dead center, the processing proceeds to step S7. If determination unit 19 determines that punch 1 has not reached the bottom dead center, the processing returns to step S2.

In step S7, press-molding device 100 calculates the molding load of workpiece 5. For example, arithmetic unit 18 of controller 20 generates a load waveform indicating the relationship between the load detected by load sensor 12 and the position of punch 1, and calculates the molding load of workpiece 5 based on the generated load waveform.

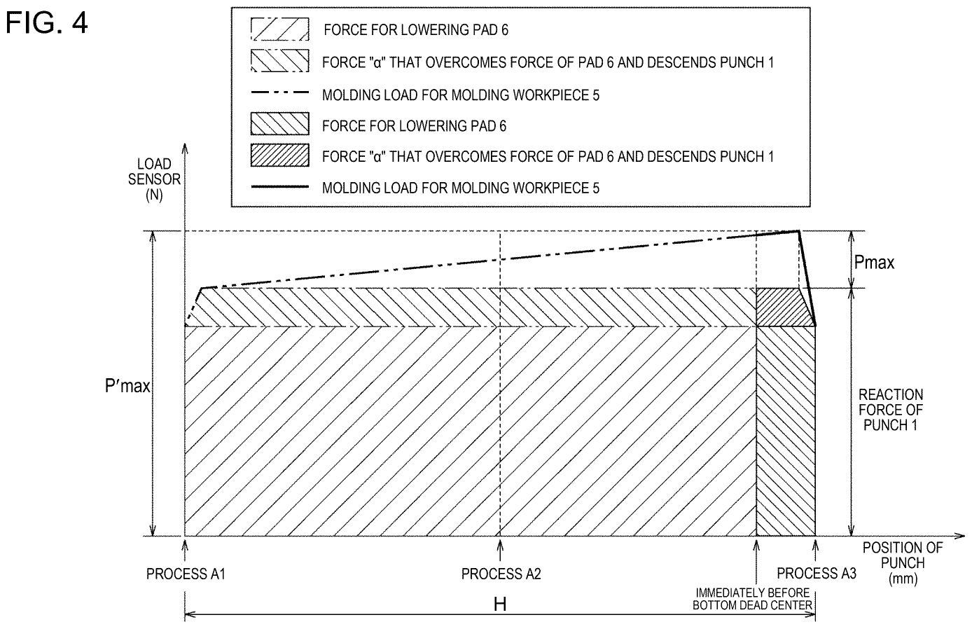

Here, the calculation of the molding load of workpiece 5 will be described with reference to FIG. 4.

FIG. 4 is a graph illustrating an example of a relationship between a force on punch 1 side or a force for lowering pad 6 when workpiece 5 is subjected to molding work by press-molding device 100, a force “α” that overcomes the force of pad 6 and descends punch 1 in the pressing direction (Z direction), a molding load for performing molding work on workpiece 5, and the position of punch 1, and the relationship between the load applied to load sensor 12 and the position of punch 1. Processes A1 to A3 illustrated in FIG. 4 correspond to processes A1 to A3 illustrated in FIG. 2, and the reference sign “H” illustrated in FIG. 4 corresponds to pushing amount H illustrated in FIG. 2.

In FIG. 4, from process A1 in which punch 1 comes into contact with workpiece 5 to process A2 in the intermediate operation, and immediately before process A3 in which punch 1 reaches the bottom dead center, or immediately before process A3 in FIG. 2, each force is applied to punch 1 side, but load sensor 12 does not detect the load. (the force and the molding load indicated by two-dot chain line in FIG. 4)

However, load sensor 12 detects the load until punch 1 reaches the bottom dead center immediately before process A3 in which punch 1 reaches the bottom dead center or from immediately before process A3 in FIG. 2 until punch 1 reaches the bottom dead center. (as illustrated in FIG. 4, a period of time from when load sensor holding member 35 and bottomed component 34 come into contact with each other immediately before the bottom dead center to when the bottom dead center is reached)

At the left end of the graph illustrated in FIG. 4, when the tip of punch 1 starts contacting workpiece 5 as indicated by process A1 in FIG. 2, the relationship among the forces of punch 1, workpiece 5, and pad 6 is such that the forces are balanced between punch 1 side and pad 6 side.

That is, the following relational expression (1) is established.

(Equation 1)

$$“ The force on punch 1 side ( the force for lowering pad 6 ) ” = “ the force on pad 6 side ( the reaction force for returning pad 6 ) ” \qquad ( 1 )$$

This is because the pressure in cylinder 8 is controlled to be always constant and a reaction force against the force from punch 1 is generated in pad 6.

From a state in which the force on punch 1 side and the force on pad 6 side are balanced, punch 1 is further descended and pushed into hollow portion 2a of die 2 as illustrated in process A2 in FIG. 2, and thus a force is further applied to punch 1. Specifically, the force “α” that overcomes the force of pad 6 and descends punch 1 in the pressing direction (Z direction) and the molding load for performing molding work on workpiece 5 are applied on a side of punch 1. During this time, the force on the side of punch 1 becomes greater than the reaction force on a side of pad 6.

That is, the following relational expression (2) is established for the force relationship from process A2 to immediately before process A3 in the graph illustrated in FIG. 4 or immediately before process A3 in FIG. 2.

(Equation 2)

$$“ The force on the side of punch 1 ( the force for lowering pad 6 ) ” = “ the force on the side of pad 6 ( the reaction force for returning pad 6 ) ” + “ α ” + “ the molding load ” \qquad ( 2 )$$

Thereafter, since the force applied to load sensor 12 is shown until punch 1 reaches the bottom dead center after load sensor holding member 35 comes into contact with bottomed component 34 immediately before process A3 in the graph illustrated in FIG. 4 or immediately before process A3 in FIG. 2, the following relational expression (3) is established.

(Equation 3)

$$“ The force applied to load sensor 12 ” = “ the force on the side of pad 6 ( the reaction force for returning pad 6 ) ” + “ α ” + “ the molding load ” \qquad ( 3 )$$

The force “α” is maintained at a predetermined value except at the start and end of the application of the force “α”. Immediately after the application of the force “α” is started, the force “α” gradually increases to the predetermined value. Since the application of the force “α” is completed immediately before the bottom dead center of punch 1, the force “α” gradually decreases from immediately before the bottom dead center of punch 1 and becomes 0 at the bottom dead center of punch 1.

Here, since the molding load is a force for performing molding work on workpiece 5, the molding load gradually increases as illustrated in FIG. 4 while the force “α” is maintained at the predetermined value. While the force “α” is maintained at the predetermined value, punch 1 is pushed into workpiece 5 pressed by material presser 3, and the pushing amount of punch 1 increases. Therefore, the molding load for performing molding work on workpiece 5 gradually increases. Then, the molding load is maximized immediately before the bottom dead center of punch 1. The molding load decreases as the force “α” decreases, and becomes zero at the bottom dead center of punch 1.

When punch 1 reaches the bottom dead center in process A3 of the graph illustrated in FIG. 4, the force “α” and the molding load are eliminated, and the relationship of the forces of punch 1, workpiece 5, and pad 6 is balanced again between the side of punch 1 and the side of pad 6.

Here, the following relational expression (4) is established for maximum value P′max of the load detected by load sensor 12 before the bottom dead center of punch 1.

(Equation 4)

$$“ Maximum value {P}^{′} max for force applied to load sensor 12 ” = “ the reaction force of punch 1 ” + “ molding load P max ” \qquad ( 4 )$$

Specifically, the following relational expression (5) is established.

(Equation 5)

$$“ Maximum value {P}^{′} max for the force applied to load sensor 12 ” = “ the force on pad 6 ( the reaction force for returning pad 6 ) ” + “ α ” + “ molding load P max ” \qquad ( 5 )$$

This is because since load sensor 12 is disposed between piston rod 7 and load sensor holding member 35, load sensor 12 can sense the load without being affected by the sliding resistance between material presser 3 and punch 1.

Therefore, the following relational expression (6) holds for molding load Pmax.

(Equation 6)

$$“ Molding load P max ” = “ maximum value {P}^{′} max of the force applied to load sensor 12 ” - “ the reaction force of punch 1 ” \qquad ( 6 )$$

Specifically, the following relational expression (7) is established.

(Equation 7)

$$“ Molding load P max ” = “ maximum value {P}^{′} max of the force applied to load sensor 12 ” - “ the force on the side of pad 6 ( the reaction force for returning pad 6 ) ” - “ α ” \qquad ( 7 )$$

Here, the force on the side of pad 6 (the reaction force for returning pad 6) can be expressed by the following relational expression (8).

(Equation 8)

$$“ The force on the side of pad 6 ( the reaction force for returning pad 6 ) ” = “ the thrust of cylinder 8 ” \qquad ( 8 )$$

The thrust of cylinder 8 can be obtained by the following equation (9) from the Pascal principle.

(Equation 9)

$$“ Thrust ( F ) of the cylinder ” = “ pressure receiving area ( A ) of piston rod 7 ” \times “ internal pressure ( P ) of the cylinder ” \times “ thrust efficiency ( μ ) of the cylinder ” \qquad ( 9 )$$

In the equation (9),
F represents thrust (N) of the cylinder,
A represents the pressure receiving area of the piston rod (mm²), and
P represents internal pressure (MPa) of the cylinder.

As described above, the force on the side of pad 6 (the reaction force for returning pad 6) and the force “α” for punch 1 to lower pad 6 with a force stronger than the force of pad 6 are forces generated in punch 1 when punch 1 is descended, and are also referred to as reaction force of punch 1. Therefore, molding load Pmax can be calculated by arithmetic unit 18 by subtracting the reaction force of punch 1 from maximum value P′max of the force applied to load sensor 12.

Molding load Pmax for molding workpiece 5 is calculated by arithmetic unit 18 by performing a process of subtracting the constant force on the side of pad 6 (the reaction force for returning pad 6) and the force “α” for punch 1 to lower pad 6 with a force stronger than the force of pad 6 from maximum value P′max of the force applied to load sensor 12.

Returning to FIG. 3, in step S8, press-molding device 100 determines whether to change pushing amount H of punch 1 based on molding load Pmax of workpiece 5 calculated in step S7 by determination unit 19. Molding load Pmax can be used to determine whether workpiece 5 is subjected to molding work into a predetermined shape. For example, determination unit 19 of controller 20 determines whether to change pushing amount H based on whether molding load Pmax is within a predetermined numerical range.

If determination unit 19 determines in step S8 that pushing amount H is to be changed, the processing proceeds to step S9. If determination unit 19 determines that pushing amount H is not to be changed, the processing proceeds to step S10.

In step S9, press-molding device 100 changes die height DH (see FIG. 2). For example, determination unit 19 of controller 20 determines a set value of changed die height DH from pushing amount H of punch 1. Determination unit 19 transmits the changed set value of die height DH to press controller 15 to change die height DH. Thus, driver 32 is controlled with changed die height DH.

In step S10, determination unit 19 of press-molding device 100 determines whether to continue the molding work. If determination unit 19 determines to continue the molding work, the processing returns to step S1. If determination unit 19 determines not to continue the molding work, the processing ends.

### [Effects]

Press-molding device 100 according to the present exemplary embodiment processes workpiece 5, and includes punch 1, die 2, material presser 3, pad 6, pressing portion 33, piston rod 7, load sensor 12, load sensor holding member 35, and bottomed component 34 as an example of the stopper. Die 2 has hollow portion 2a into which punch 1 is inserted. Material presser 3 is disposed on the outer periphery of punch 1 and faces die 2. Pad 6 is disposed in hollow portion 2a of die 2 and is movable in the moving direction of punch 1. Pressing portion 33 presses pad 6 toward punch 1. Load sensor 12 is disposed between piston rod 7 and load sensor holding member 35, and detects a load applied to pad 6, piston rod 7 of pressing portion 33, and load sensor holding member 35. Bottomed component 34 is disposed below load sensor holding member 35 so as to be contactable with load sensor holding member 35. With such a configuration, only a load applied to workpiece 5 can be detected with high accuracy. In other words, in press-molding device 100, since load sensor 12 is disposed between piston rod 7 and load sensor holding member 35 on a side of die 2, for example, even if the sliding resistance between material presser 3 and punch 1 increases due to a disturbance factor or the like, the effect on the detection of the load of load sensor 12 can be reduced, only the load applied to workpiece 5 can be accurately detected, and the load sensing can be stably performed on workpiece 5.

In addition, pad 6, piston rod 7 of pressing portion 33, load sensor 12, and load sensor holding member 35 may be connected and fixed in the axial direction and integrated to constitute integrated component 91, and pad 6 movable in the moving direction of the punch 1 and cylinder 8 having piston rod 7 may be provided. With such a configuration, pad 6 can be pressed toward punch 1.

Further, pad 6, piston rod 7 of pressing portion 33, load sensor 12, and load sensor holding member 35 may be connected and fixed in the axial direction and integrated to constitute integrated component 91, and the load detected by load sensor 12 may be a load detected from when a lower surface of load sensor holding member 35 of integrated component 91 comes into contact with bottomed component 34. By measuring the load in such a manner, only the load applied to workpiece 5 can be detected more accurately.

In addition, pressing portion 33 is an air cylinder, and may further include pressure adjustment unit 90 that controls the internal pressure of air cylinder 7 to a constant pressure so as to cause a reaction force of pad 6 against a force for punch 1 to lower pad 6 to always become a constant force when punch 1 moves downward. Pressure adjustment unit 90 may include electromagnetic valve 9, pressure gauge 10, and regulator 11 so as to always control the internal pressure of the air cylinder to a constant pressure. With such a configuration, pad 6 can be pressed with a constant pressure, and only the load applied to workpiece 5 can be detected more accurately.

In addition, press-molding device 100 may acquire information for detecting the position of punch 1 by position sensor 13. With such a configuration, the position of punch 1 can be detected, and only the load applied to workpiece 5 can be detected with higher accuracy.

Press-molding device 100 may further include driver 32 that drives punch 1, and controller 20 that controls driver 32, pressing portion 33, and load sensor 12. Controller 20 may calculate molding load Pmax for molding workpiece 5, based on load P′max detected by load sensor 12 and the reaction force of punch 1, and control driver 32 based on molding load Pmax. With such a configuration, only load (molding load) Pmax applied to workpiece 5 can be accurately detected, and driver 32 can be accurately controlled based on molding load Pmax. Accordingly, stabler molding work can be performed.

Molding load Pmax for molding workpiece 5 may be a load calculated by subtracting the reaction force for returning pad 6 and the force for lowering punch 1 by overcoming the force of pad 6 from load P′max detected by load sensor 12. With such a configuration, only load (molding load) Pmax applied to workpiece 5 can be detected more accurately, and driver 32 can be controlled accurately based on molding load Pmax. Accordingly, stabler molding work can be performed.

In the exemplary embodiment described above, the example in which the material of workpiece 5 is the SUS301-EH material has been described, but the present disclosure is not limited thereto. Furthermore, the thickness of workpiece 5 is not limited thereto. Workpiece 5 can include various metal materials.

Furthermore, lower mold 31 may have a mold structure in which a clearance between die 2 and pad 6 is stabilized by a positioning pin or the like so that the sliding resistance does not affect load sensor 12 and an axis of pad 6 is not inclined instead of being in a perpendicular state.

In the exemplary embodiment described above, the example has been described in which position sensors 13 are provided at the four corners of lower mold 31 in press-molding device 100, but the number and arrangement places of position sensors 13 are not limited.

In the exemplary embodiment described above, the example has been described in which gap sensors 14 are provided at the four corners of die plate 4 in press-molding device 100, but the number and arrangement places of gap sensors 14 are not limited.

Further, in the exemplary embodiment described above, the example in which press-molding device 100 includes gap sensor 14 has been described, but the present disclosure is not limited thereto. Gap sensor 14 is not an essential component.

In the flowchart illustrated in FIG. 3, each step may be added, deleted, or integrated. For example, steps S3 to S5 are not essential processing and may be deleted.

In the exemplary embodiment described above, the example has been described in which pressing portion 33 is cylinder 8 having piston rod 7, but the present disclosure is not limited to this example. Pressing portion 33 is only required to be configured to press pad 6 toward punch 1. For example, it may be a hydraulic cylinder or the like.

The exemplary embodiment is described above to exemplify the technique disclosed in the present application. However, the technique in the present disclosure is not limited thereto, and may also be applied to an exemplary embodiment in which changes, replacements, additions, omissions, or the like are made as appropriate.

Although the present disclosure is fully described with reference to the preferred exemplary embodiments and with reference to the accompanying drawings, various variations and modifications are clear to those skilled in the art. Such variations and modifications are to be understood as being included within the scope of the present disclosure as set forth in the appended claims, unless departing from the scope of the present disclosure.

A general and specific aspect of the present disclosure may be implemented by a system, a method, a computer program, a computer-readable storage medium, and a combination of the above.

### Supplementary Note

The above description of the exemplary embodiments discloses the following techniques.
(Technique 1) A press-molding device according to an aspect of the present disclosure processes a workpiece, and includes:
a punch;
a die including a hollow portion into which the punch is inserted;
a material presser disposed on an outer periphery of the punch and facing the die;
a pad that
   is disposed in the hollow portion of the die,
   is movable in a moving direction of the punch, and
   includes a surface that is on a side opposite to the moving direction and is configured to be in contact with the workpiece;
a pressing portion that
   includes a piston rod including a first end portion on the side opposite to the moving direction, the first end portion being in contact with the pad, and
   is configured to press the pad toward the punch by moving the piston rod in a direction opposite to the moving direction; and
a load sensor that is in contact with a second end portion of the piston rod in the moving direction and detects a load applied to the pad and the piston rod.
(Technique 2) The press-molding device according to (Technique 1) may further include a load sensor holding member, wherein
the load sensor may be disposed between the piston rod and the load sensor holding member in the moving direction and may detect a load applied to the pad, the piston rod, and the load sensor holding member.
(Technique 3) The press-molding device according to (Technique 2) may further include a stopper disposed below the load sensor holding member in the moving direction so as to be contactable with the load sensor holding member.
(Technique 4) In the press-molding device according to (Technique 3),
the pad, the piston rod, the load sensor, and the load sensor holding member may be connected and fixed in an axial direction and integrated to constitute an integrated component, and
the load sensor may detect the load during a period of time from when the integrated component comes into contact with the stopper to when the punch reaches a bottom dead center.
(Technique 5) In the press-molding device according to (Technique 1) or (Technique 2),
the pressing portion may be an air cylinder,
when the punch moves in the moving direction, the punch presses the pad to apply a force to the pad in the moving direction,
the press-molding device may further include a pressure adjustment unit that controls an internal pressure of the air cylinder to a constant pressure so as to cause a reaction force of the pad against the force applied by the punch.
(Technique 6) The press-molding device according to (Technique 5) may further include:
a driver that drives the punch; and
a controller that controls the pressure adjustment unit, the driver, the pressing portion, and the load sensor, wherein
the controller
may calculate a molding load for molding the workpiece based on the load detected by the load sensor and a reaction force of the punch, and
may control the driver based on the molding load.
(Technique 7) In the press-molding device according to (Technique 6),
the molding load for molding the workpiece may be a load calculated by subtracting a reaction force for moving the pad in the moving direction and a force for moving the punch in the moving direction by overcoming the force of the pad from the load detected by the load sensor.
(Technique 8) The press-molding device according to (Technique 1) or (Technique 2) may further include:
a driver that drives the punch; and
a controller that controls the driver, the pressing portion, and the load sensor, wherein
the controller
may calculate a molding load for molding the workpiece based on the load detected by the load sensor and a reaction force of the punch, and
may control the driver based on the molding load.
(Technique 9) In the press-molding device according to (Technique 8),
the molding load for molding the workpiece may be a load calculated by subtracting a reaction force for moving the pad in the moving direction and a force for moving the punch in the moving direction by overcoming the force of the pad from the load detected by the load sensor.

With each of these configurations, it is possible to provide a press-molding device capable of accurately detecting only a load applied to a workpiece.

Note that by appropriately combining any exemplary embodiments or modifications among the various exemplary embodiments or modifications described above, the effects of the respective exemplary embodiments or modifications can be obtained. Additionally, combinations of exemplary embodiments, combinations of examples, or combinations of exemplary embodiments and examples are possible, and combinations of features in different exemplary embodiments or examples are also possible.

### INDUSTRIAL APPLICABILITY

The press-molding device of the present disclosure is useful, for example, as a device that performs punching, bending, drawing, or the like on any workpiece used for home electric appliances, medical devices, or the like.

### REFERENCE MARKS IN THE DRAWINGS

1: punch
2: die
2a: hollow portion
3: material presser
4: die plate
5: workpiece
6: pad
7: piston rod
8: cylinder
9: electromagnetic valve
10: pressure gauge
11: regulator
12: load sensor
13: position sensor
14: gap sensor
15: press controller
16: sensor controller
17: pressure controller
18: arithmetic unit
19: determination unit
20: controller
21: slide
22: bolster
23: servomotor
24: ball screw
25: shaft
26: press device body
30: upper mold
31: lower mold
32: driver
33: pressing portion
34: bottomed component (example of stopper)
35: load sensor holding member
90: pressure adjustment unit
91: integrated component
92: measurement object
100: press-molding device

1. A press-molding device that processes a workpiece, the press-molding device comprising:
a punch;
a die including a hollow portion into which the punch is inserted;
a material presser disposed on an outer periphery of the punch and facing the die;
a pad that
is disposed in the hollow portion of the die,
is movable in a moving direction of the punch, and
includes a surface that is on a side opposite to the moving direction and is configured to be in contact with the workpiece;
a pressing portion that
includes a piston rod including a first end portion on the side opposite to the moving direction, the first end portion being in contact with the pad, and
is configured to press the pad toward the punch by moving the piston rod in a direction opposite to the moving direction; and
a load sensor that is in contact with a second end portion of the piston rod in the moving direction and detects a load applied to the pad and the piston rod.

2. The press-molding device according to claim 1, further comprising a load sensor holding member, wherein
the load sensor is disposed between the piston rod and the load sensor holding member in the moving direction and detects a load applied to the pad, the piston rod, and the load sensor holding member.

3. The press-molding device according to claim 2, further comprising
a stopper disposed below the load sensor holding member in the moving direction so as to be contactable with the load sensor holding member.

4. The press-molding device according to claim 3, wherein
the pad, the piston rod, the load sensor, and the load sensor holding member are connected and fixed in an axial direction and integrated to constitute an integrated component, and
the load sensor detects the load during a period of time from when the integrated component comes into contact with the stopper to when the punch reaches a bottom dead center.

5. The press-molding device according to claim 1, wherein
the pressing portion is an air cylinder,
when the punch moves in the moving direction, the punch presses the pad to apply a force to the pad in the moving direction,
the press-molding device further comprising a pressure adjustment unit that controls an internal pressure of the air cylinder to a constant pressure so as to cause a reaction force of the pad against the force applied by the punch.

6. The press-molding device according to claim 5, further comprising:
a driver that drives the punch; and
a controller that controls the pressure adjustment unit, the driver, the pressing portion, and the load sensor, wherein
the controller
calculates a molding load for molding the workpiece based on the load detected by the load sensor and a reaction force of the punch, and
controls the driver based on the molding load.

7. The press-molding device according to claim 6, wherein
the molding load for molding the workpiece is a load calculated by subtracting a reaction force for moving the pad in the moving direction and a force for moving the punch in the moving direction by overcoming the force of the pad from the load detected by the load sensor.

8. The press-molding device according to claim 1, further comprising:
a driver that drives the punch; and
a controller that controls the driver, the pressing portion, and the load sensor, wherein
the controller
calculates a molding load for molding the workpiece based on the load detected by the load sensor and a reaction force of the punch, and
controls the driver based on the molding load.

9. The press-molding device according to claim 8, wherein
the molding load for molding the workpiece is a load calculated by subtracting a reaction force for moving the pad in the moving direction and a force for moving the punch in the moving direction by overcoming the force of the pad from the load detected by the load sensor.
